(19) United States
(12) Patent Application Publication
(10) Pub. No.: US 2020/0140180 A1
(43) Pub. Date: May 7, 2020

(54) COFFEE CUP SLEEVE WITH OUTSIDE POUCH

(71) Applicant: Marguerite A. Gray, Apex, NC (US)

(72) Inventor: Marguerite A. Gray, Apex, NC (US)

(21) Appl. No.: 16/182,026

(22) Filed: Nov. 6, 2018

(51) Int. Cl. B65D 81/38; A47G 23/02; F16M 13/02

(52) U.S. Cl. CPC B65D 81/3876; F16M 13/02; A47G 23/0216

(57) ABSTRACT

A hot drink cup sleeve is presented with a pouch on the outside circumference designed for holding additives and accessories and has expanding sides, wherein the height of the pouch is shorter than the drink cup and is positioned between the top and the bottom edge of the drink cup.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a sleeve for a hot cup of hot liquid, like coffee. In particular, it relates to a cup sleeve with a pouch designed to hold drink accessories and additives.

### Description of Related Art

The use of paper cups for hot beverages, such as tea and coffee, has been a mainstay of take-out restaurants and fast food places for decades. While these devices easily hold scalding hot liquids, they are not without some problems. The biggest of which is the outer surface, the circumferential side gets extremely hot since such paper is not a very good heat insulator.

More than 20 years ago, a cup sleeve was developed allowing the user to slip the sleeve around the sides of the cup and create insulation between the extremely hot outer cup surface and the user's hand holding the cup. There are typically just big enough to slip over the outer surface of the cup from the bottom. Most hot drink cups are tapered, so by tapering the sleeve as well, the sleeve will not slip off the top of the cup.

### BRIEF SUMMARY OF THE INVENTION

The present invention relates to a hot drink cup sleeve that positions a pouch on the outside of the sleeve for placement of drink additives and accessories such that they all can be carried in one hand.

Accordingly, in one embodiment, there is a sleeve for insulation use on the outside circumference of a hot drink cup, the improvement comprising positioning a pouch on the outside surface of the sleeve of a size and shape designed to accommodate one or more hot drink accessories or additives.

### BRIEF DESCRIPTION OF THE DRAWINGS

FIG. 1 is a frontal perspective view of the sleeve of the present invention.

FIG. 2 is a frontal perspective view of the sleeve of the present invention on a hot drink cup.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “sleeve” refers to roughly cylindrical sleeve that fits tightly over cylindrical handle-less paper hot drink cups to insulate the drinker's hands from the hot outer circumference surface of the hot drink cup. Sleeves are typically made of textured paperboard, but can be found made of other materials. Sleeves allow coffee houses, fast food restaurants, and other vendors to avoid double-cupping, the practice of using two (or more) nested paper cups for a single hot beverage. Some paper cup holders carry advertisements.

As used herein, the term “hot drink cup” refers to a paper or other disposable or non-disposable material used for take-out wherein a hot beverage is contained in the cup which heats the outside circumference of the cup. Hot drinks include, coffee, hot tea, soups, and the like which can be placed in the cup.

As used herein, the term “outside surface” or “outside circumference” refers to the circumferential outer surface of the hot drink cup where the user would normally hold the cup. In the case of the sleeve, it is the outer surface where the user would hold the cup.

As used herein, the term “pouch” refers to a pocket like container that is positioned on the outside surface of the sleeve and is large enough to fit one or more drink accessories or additives. Generally, there will be no top on the pouch. The pouch can be a fixed size or in one embodiment, it is expandable, for example, by use of pleated folds in the side of the pouch which create expanding sides in the pouch.

As used herein, the term “hot drink accessory” refers to tools to be used with the hot beverage such as stir sticks and the like.

As used herein, the term “hot drink additive” refers to edible items added to the hot beverage such as milk, sugar, creamer, flavoring, and the like.

### DRAWINGS

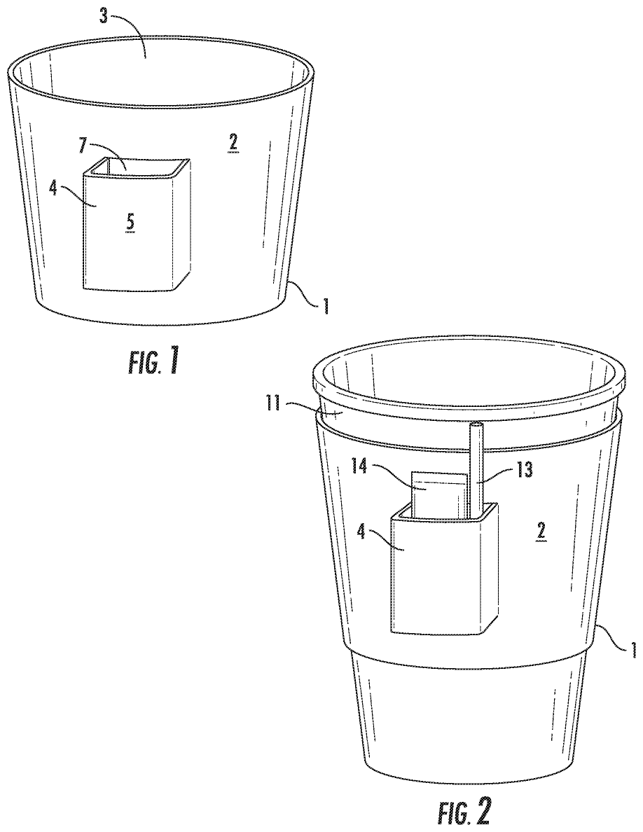

Now referring to the drawings, FIG. 1 is frontal view of the sleeve with the pouch on the front side. Sleeve 1 is shown with outer circumference 2 and inner surface 3 which fits against the outer circumference of the coffee cup. Pouch 4 is shown with outside surface 5 and inside the pouch 7.

FIG. 2 is a frontal view of the sleeve tightly slipped onto a hot drink cup. Hot drink cup 11 has sleeve 1 installed with pouch 4 having a stir stick 13 and a sugar packet 14 inside the pouch for carrying.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. An improved sleeve of a first height having a top and bottom edge for insulation use on the outside circumference of a hot drink cup, the improvement comprising a pouch of a second height on the outside surface of the sleeve of a size and shape designed to accommodate one or more hot drink accessories or additives wherein the first height is greater than the second height and the pouch has been positioned between the top and bottom edge of the sleeve.

2. The sleeve according to claim 1 wherein the pouch has expanding sides.

3. The sleeve according to claim 1 wherein the pouch is designed to accommodate at least one from the group consisting of milk, sugar, creamer, flavoring, and stir stick.

4. The sleeve according to claim 1 wherein a hot drink cup is within the sleeve.
